(19) United States
(12) Patent Application Publication
(10) Pub. No.: US 2023/0215416 A1
(43) Pub. Date: Jul. 6, 2023

(54) BIQUAD HYBRID ACTIVE NOISE CANCELLATION (ANC) DEVICE AND RELATED CONTROLLER

(71) Applicant: BlueX Microelectronics ( Hefei ) Co., Ltd., Hefei City (CN)

(72) Inventors: Hao-Ming Chen, Hsinchu County (TW); Yi-Chun Lu, Hsinchu County (TW); HONGYU LI, Palo Alto, CA (US)

(73) Assignee: BlueX Microelectronics ( Hefei ) Co., Ltd., Hefei City (CN)

(21) Appl. No.: 17/569,469

(22) Filed: Jan. 5, 2022

(51) Int. Cl. G10K 11/178; H04R 1/10

(52) U.S. Cl. CPC G10K 11/17881; H04R 1/1083; G10K 2210/1081; G10K 2210/3027

(57) ABSTRACT

A biquad hybrid active noise cancellation (ANC) device includes a reference microphone (MIC), an error MiC, a speaker, and a controller. The controller is connected to the reference MiC, the error MiC, and the speaker, wherein the controller includes a feedforward biquad ANC filter, a feedback biquad ANC filter, and a mixer, the feedforward biquad ANC filter processes reference noise to generate a feedforward noise control signal, the feedback biquad ANC filter processes residual noise received by the error MiC to generate a feedback noise control signal, and the feedforward noise control signal generated by the feedforward biquad ANC filter and the feedback noise control signal generated by the feedback biquad ANC filter are added by the mixer and transmits to the speaker for playing.

### BACKGROUND OF THE INVENTION

### 1. Field of the Invention

The present invention relates to an active noise cancellation (ANC) device and a related controller, and particularly to a biquad type hybrid ANC device and a related controller.

### 2. Description of the Prior Art

Currently, an active noise cancellation (ANC) device applied to a headset has three types of devices, wherein the three types of devices are feedforward type ANC device, feedback type ANC device, and hybrid type ANC (combination of the feedforward ANC device and the feedback type ANC device) device. Each type device of the three types of devices has its own compromise between cancellation ability and power consumption, headset performance and cost, and processing delay and cancellation bandwidth.

An operational principle of the feedforward ANC device generates an opposite ANC signal to reverse received noise and thus eventually cancels the received noise. A reference microphone (MIC) receives environment noise and generates the opposite ANC signal through an ANC digital filter within the headset, wherein the opposite ANC signal and the received noise will be cancelled out each other in ear canal. Specifically, the ANC digital filter mainly compensates a difference between MIC/speaker response and the headset response, and equalizes distorted headset response.

An operational principle of the feedback type ANC device processes the received noise residue and then uses a feedback adaptive filter to construct an opposite ANC signal to cancel the received noise. The feedback adaptive filter only can process a regular noise source due to prediction property of the feedback adaptive filter. If the feedback adaptive filter processes irregular noise, error enhancement may happen due to divergent of the feedback adaptive filter.

The hybrid ANC device combines the feedforward ANC device and the feedback ANC device, and has both advantages of the feedforward ANC device and the feedback ANC device. The hybrid ANC device commonly has a pair of MICs for processing feedforward and feedback part, respectively. The feedforward part uses reference MiC to generate the opposite ANC signal through the feedforward biquad ANC filter, the feedback part processes the residual noise received by error MiC and then uses the feedback biquad ANC filter to construct the opposite ANC signal. Due to use of the feedforward ANC device and the feedback ANC device simultaneously, the hybrid ANC device has ultimately higher cost and complexity. Therefore, how to reduce the cost and complexity of the hybrid ANC device is an important issue of a designer of the hybrid ANC device.

### SUMMARY OF THE INVENTION

The purpose of the present invention is to provide a biquad type ANC device, including a reference microphone (MIC), an error MiC and a controller. The controller includes a feedforward biquad ANC filter, a feedback biquad ANC filter, and a mixer. The feedforward biquad ANC filter processes noise received by the reference MiC and generates a reversed noise control signal through feedforward biquad ANC filter. The feedback biquad ANC filter processes the received noise residue and then uses the feedback biquad ANC filter to construct the opposite ANC signal. Using biquad ANC filter has much lower cost and complexity than using traditional finite impulse response filter (FIR).

The other purpose of the present invention is to provide a processor. The processor processes the error signal received by error MiC and updates the filter coefficients for both feedforward biquad ANC filter and feedback biquad ANC filter. The feedforward and feedback parts with updated coefficients can process the noise when environment is changed.

Therefore, the present invention has advantage than conventional one, which is described as follows:

The invention uses biquad ANC filter to replace conventional FIR filter. Thus, the invention needs much less multipliers than conventional one. Specifically, conventional hybrid type ANC needs at least 128 multipliers, and the present invention biquad structure (6 biquad ANC filters) needs only 30 multipliers. Obviously, the present invention is more progressive than conventional one.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1, 2 are diagrams illustrating functional blocks of a biquad type hybrid ANC device according to an embodiment of the present invention.

FIG. 3 is a diagram illustrating a structure of the biquad type hybrid ANC device.

FIGS. 4, 5 are diagrams illustrating a structure of the biquad ANC filter.

### DETAILED DESCRIPTION

The detailed description is described as follow. The scale of drawing may not be expressed as real case, which is which is not limited in the present invention.

This invention can be applied to personal audio devices, such as wired headset, smart phone, wireless headset and other audio related headset, which is not limited in the invention. The controller in the present invention can be constructed by one or multiple chips. In the other case, the controller can be implemented for audio device (ex, mobile device), or integrated in audio chip for wireless headset, headphone, which is not limited in the present invention. Specifically, the controller can be Microprocessor, digital signal processor (DSP), or other similar processor, which is not limited in the present invention.

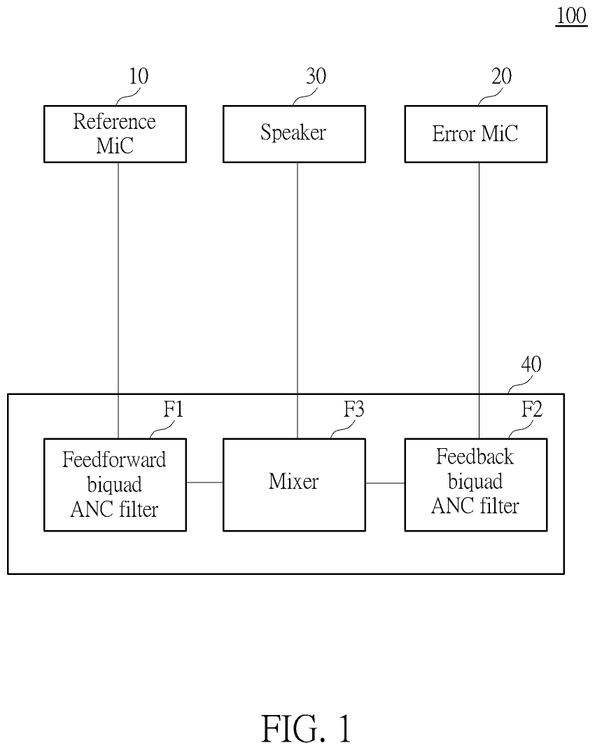

Please refer to FIG. 1. FIG. 1 is a diagram illustrating functional blocks of a biquad type hybrid ANC device 100 according to an embodiment of the present invention.

As shown in FIG. 1, the hybrid ANC device 100 includes a reference MiC 10, an error MiC 20, a speaker 30, and a controller 40, wherein coupling relationships between the reference MiC 10, the error MiC 20, the speaker 30, and the controller 40 can be referred to FIG. 1, so further description thereof is omitted for simplicity.

The reference MiC 10 is mainly used for receiving environment noise. Specifically, the controller 40 processes the environment noise to generate an opposite noise control signal for the speaker 30 playing. The reference MiC in 10 can be microphone, pickup or other analog/digital devices which can receive the environment noise.

The error MiC 20 is mainly for receiving error noise. The error MiC 20 is commonly positioned in the range that can properly receive the environment noise. The noise received by the error MiC 20 is totally equal to an opposite ANC signal which speaker 30 generates. In the present invention, the opposite ANC signal is called error signal. Similar to the reference MiC 10, the error MiC 20 can be microphone, pickup, other analog/digital devices which can receive the environment noise.

The speaker 30 is used for transmitting the opposite noise control signal, which can be used to destruct the environment noise. The speaker 30 includes a speaker unit 31 and a driving unit 32, which is connected to the speaker unit 31. The driving unit 32 receives a digital signal from a mixer F3 and converts the digital signal into an analog signal for the driving unit 31.

The controller 40 connects to the reference MiC 10, the error MiC 20, and the speaker 30 by specific PINs, which negotiates the inter-connected signal for further processing. Specifically, the controller 40 includes a biquad ANC feedforward biquad ANC filter F1, a biquad ANC feedback biquad ANC filter F2, and the mixer F3. In addition, functions of the biquad ANC feedforward biquad ANC filter F1, the biquad ANC feedback biquad ANC filter F2, and the mixer F3 can be integrated to one processor or cooperated by multiple processors, which is not limited in the present invention.

As shown in FIG. 1, the feedforward biquad ANC filter F1 receives a reference signal from the reference MiC 10, and processes the reference signal by feedforward biquad ANC filter to generate a control noise signal to the mixer F3. The feedback biquad ANC filter F2 receives the error signal from the error MiC 20, and processes the error signal by feedback biquad ANC filter to generate a control noise signal to the mixer F3. Then, the control noise signals from the feedforward biquad ANC filter F1 and feedback biquad ANC filter F2 are added by the mixer F3, and an output signal generated by the mixer F3 is transmitted to the speaker 30.

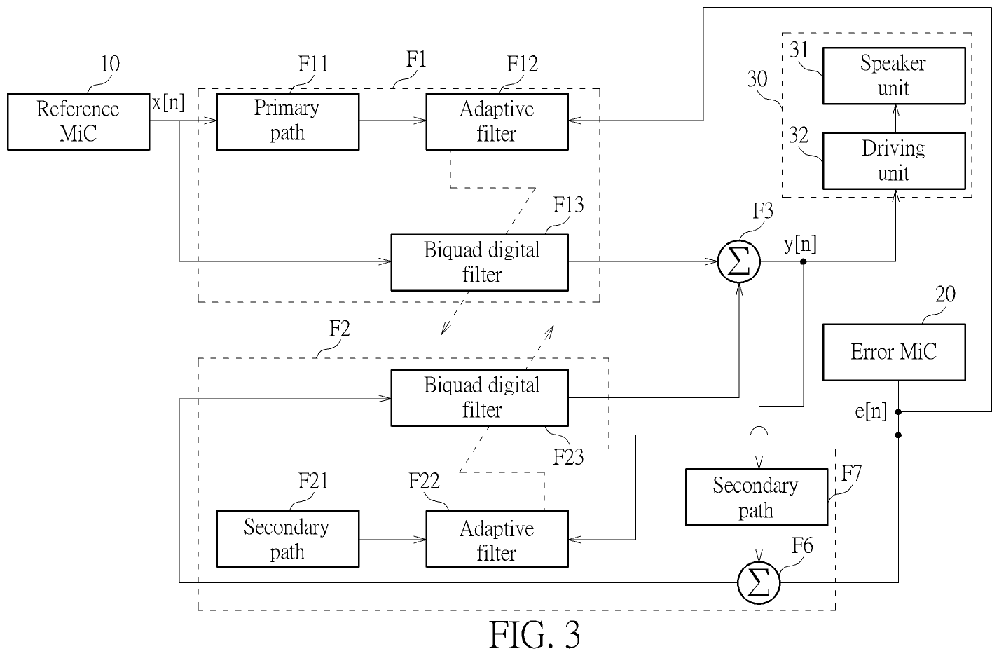

The realization of the feedforward biquad ANC filter F1 and the feedback biquad ANC filter F2 are explained by utilizing FIG. 3.

As shown in FIG. 3, the feedforward biquad ANC filter F1 includes a primary path F11, an adaptive filter F12 and a biquad digital filter F13. The primary path F11 is defined by a path between noise control signal y(n) and error signal e(n), wherein the path in the feedforward biquad ANC filter F1 corresponds to properly compensating an input signal x(n) (the environment noise) to generate the reference signal. The adaptive filter F12 adjusts filter coefficients of the biquad digital filter F13 by using the error signal and the reference signal. The adaptive filter F12 can be Least mean square error (LMS) filter or other adaptive filters, which is not limited in the present invention. The biquad digital filter F13 uses the updated coefficients and generates the opposite noise control signal to the mixer F3. In the present invention, the biquad digital filter F13 is so called biquad ANC filter.

The biquad digital filter F13 is used for estimating unknown environment factor (e.g. headphone response) and then compensate it. Both of the primary path F11 and the biquad digital filter F13 receive x(n). The digital filer F13 compensates the primary path F11 distortion by using the filter-x LMS (FxLMS) algorithm and thus minimizes an output error.

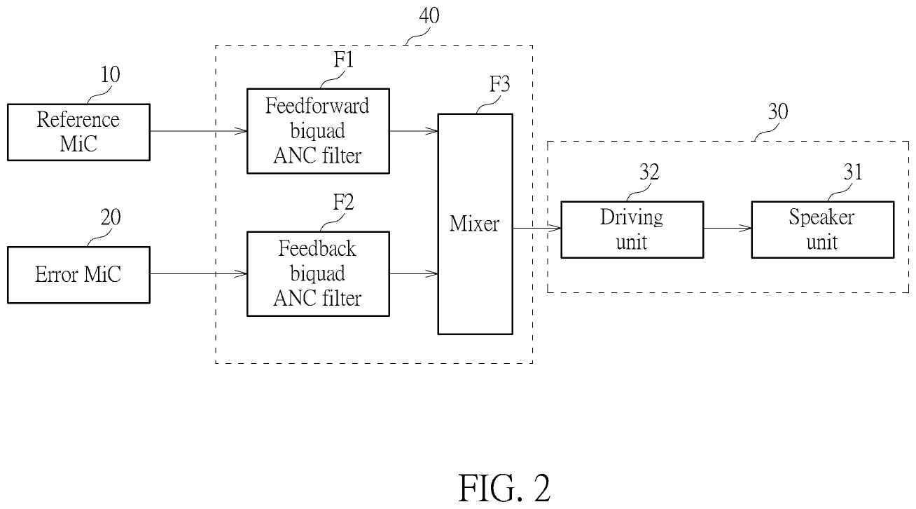

As shown in FIG. 3, the feedback biquad ANC filter F2 includes a secondary path F21, an adaptive filter F22, a biquad digital filter F23, a secondary path F7, and a mixer F6. Similar to the feedforward biquad ANC filter F1, the secondary paths F21 and F27 are defined by a path between the noise control signal y(n) and the error e(n), which processes the input signal by properly compensating and generating the reference signal. The adaptive filter F22 uses the error e(n) and the control signal y(n) to compensate the distortion. Specifically, the adaptive filter F22 uses the error e (n) and previous control signal y(n−1) to generate the latest coefficients. The feedback biquad ANC filter F2 updates the latest coefficients and thereby generate the control noise signal for the mixer F6. The adaptive filter F22 can be Least mean square error (LMS) filter or other adaptive filter, which is not limited in the present invention, and because FIG. 3 is a detail structure of FIG. 2, signals between function blocks in FIG. 3 need to be the same as signals between function blocks in FIG. 2).

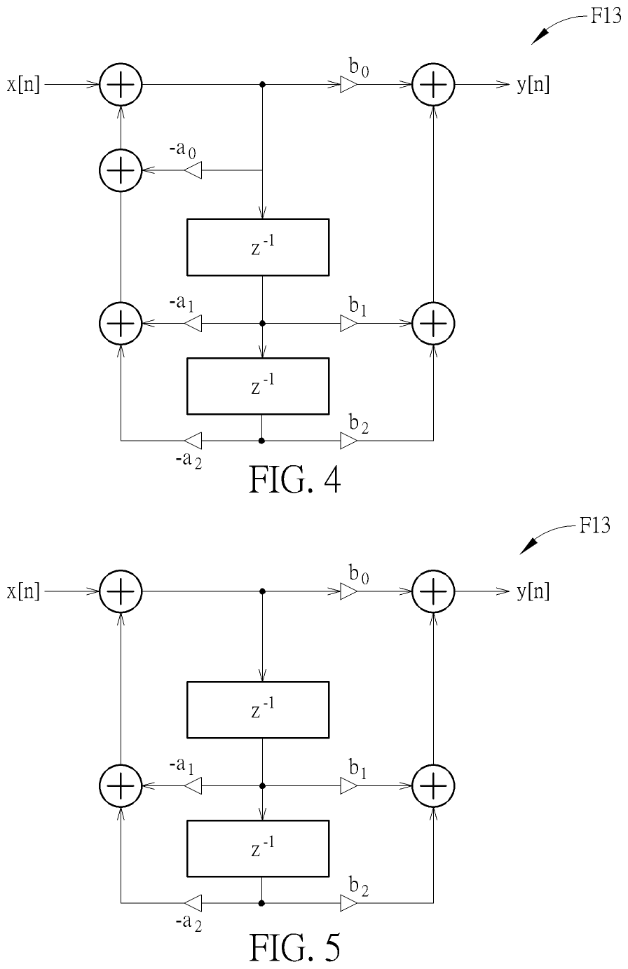

FIG. 4 shows a structure of the biquad digital filter F13, and the biquad digital filter F13 shown in FIG. 4 can execute filter function according to equation (1):

$$y [ n ] = \frac{1}{{a}_{0}} ( {b}_{0} x [ n ] + {b}_{1} x [ n - 1 ] + {b}_{2} x [ n - 2 ] - {a}_{1} y [ n - 1 ] - {a}_{2} y [ n - 2 ] ) \qquad ( 1 )$$

In equation (1), x[n], x[n−1], x[n−2] denote different filtered out sample y[n], y [n−1] and y [n−2] with corresponding time index (time index n, time index n−1, and time index n−2). In addition, b0, b1, b2, a0, a1, a2 denote filter coefficients in time index n and the z⁻¹ denotes an sampling time delay.

Specifically, the FIG. 4 shows one biquad structure (BiQ=1) for implementation. In this invention, we cascade three biquad structures (BiQs=3) for the realized case. However, a number of BiQs can be adjusted by other different application, which is not limited in the invention. Moreover, to avoid the unstable problem caused by infinite impulse response filter (IIR) filter, the filter only updates the numerator (b₀, b₁, b₂), denominator coefficients (a₀, a₁, a₂) are fixed.

In every filter process, the adaptive filter F12 updates the filter coefficients by equation (2):

b[n]=[b₀[n],b₁[n],b₂[n]]^{T}

X[n]=[x′[n],x′[n−1],x′[n−2]]^{T}

b[n]=b[n−1]+μe[n]X[n] (2)

As shown in equation (2), x′[n], x′ [n−1], x′ [n−2] denote the secondary response output with corresponding to time index n, n−1 and n−2. b₀[n], b₁[n], b₂[n] denote the filter coefficients in time index n, e[n] is the error noise in time index n, and μ is the step size of LMS filter.

In another embodiment of the present invention, the biquad digital filter F13 can also be implemented by another structure shown in FIG. 5.

In FIG. 5, coefficient a₀ can be normalized to 1 which reduces the computation complexity. The biquad digital filter F13 shown in FIG. 5 can execute filter function according to equation (3):

y[n]=b₀x[n]+b₁x[n−1]+b₂x[n−2]−a₁y[n−1]−a₂y[n−2] (3)

In equation (3), x′[n], x′[n−1], x′[n−2] denote different filtered out sample y[n], y[n−1] and y[n−2] with corresponding to time index n, n−1 and n−2. In addition, b₀, b₁, b₂, a₁ denote filter coefficients in time index n.

Similar to FIG. 4, the filter coefficients can be updated by the same equation (2):

b[n]=[b₀[n],b₁[n],b₂[n]]^{T}

X[n]=[x′[n],x′[n−1],x′[n−2]]^{T}

b[n]=b[n−1]+μe[n]X[n] (2)

As shown in equation (2), x′[n], x′[n−1], x′[n−2] denote different filtered out sample with corresponding time index n, n−1 and n−2. And b₀, b₁, b₂, a₁ denote filter coefficients in time index n and the z⁻¹ denotes a sampling time delay.

To sum up, the present invention adopts biquad ANC filter which has much lower multipliers and complexity than conventional finite impulse response (FIR) filter. Specifically, the conventional hybrid ANC structure needs at least 128 multipliers, but the biquad hybrid ANC filter in the present invention needs only 30 multipliers (6 BiQs) for operating. Therefore, compared to the prior art, the present invention has lower cost and complexity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A biquad hybrid active noise cancellation (ANC) device, comprising:
a reference microphone (MIC);
an error MiC;
a speaker, and;
a controller connecting to the reference MiC, the error MiC, and the speaker, wherein the controller comprises a feedforward biquad ANC filter, a feedback biquad ANC filter, and a mixer, the feedforward biquad ANC filter processes reference noise to generate a feedforward noise control signal, the feedback biquad ANC filter processes residual noise received by the error MiC to generate a feedback noise control signal, and the feedforward noise control signal generated by the feedforward biquad ANC filter and the feedback noise control signal generated by the feedback biquad ANC filter are added by the mixer and transmits to the speaker for playing.

2. A controller, comprising:
a feedforward biquad ANC filter processing reference noise received by a reference MiC to generate a feedforward noise control signal;
a feedback biquad ANC filter processing residual noise received by an error MiC to generate a feedback noise control signal; and
a mixer adding the feedforward noise control signal and the feedback noise control signal and transmits it to a speaker for playing.
